(19) United States
(12) Patent Application Publication
(10) Pub. No.: US 2007/0144916 A1
(43) Pub. Date: Jun. 28, 2007

(54) Method for structuring the aerodynamics of components in aircraft gas turbines

(75) Inventors: Martin Bussmann, Schwabhausen (DE); Thomas Kraenzler, Salem (DE); Albin Platz, Ried-Baindlkirch (DE); Juergen Steinwandel, Uhldingen-Muehlhofen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 10/582,261

(22) PCT Filed: Nov. 12, 2004
(86) PCT No.: PCT/DE04/02507

§ 371 Date: Feb. 27, 2007

(30) Foreign Application Priority Data
Dec. 10, 2003 (DE) 103 57 629.0

(51) Int. Cl. B23H 3/02

(52) U.S. Cl. 205/649

(57) ABSTRACT

A method is disclosed for manufacturing blades arranged on the outside circumference of an impeller in a BLISK technology by contouring by means of an electrochemical machining method using molded cathodes. The surface of the blades in contouring is equipped with a negative structure in relation to the molded cathode surface and at the same time a structure that minimizes boundary layers in one manufacturing step. The electrochemical machining method is a pulsed method.

This application claims the priority of International Application No. PCT/DE2004/002507, filed Nov. 12, 2004, and German Patent Document No. 103 57 629.0, filed Dec. 10, 2003, the disclosures of which are expressly incorporated by reference herein.

### BACKGROUND AND SUMMARY OF THE INVENTION

The present invention relates to a method for structuring the aerodynamics of components in aircraft gas turbines.

A method for manufacturing an impeller with blades arranged on the outside circumference of a wheel disk in the BLISK design is known from European Patent 0 327 657 A1. In this method the blades are roughly premachined. Molded cathodes then engage in the gaps between the blades and the blades are machined to the finished contour by electrochemical machining methods, e.g., ECM (electrochemical machining).

The efficiency of compressors or compressor rotors in axial machines in particular, such as those known from aircraft gas turbines, depends to a significant extent on the aerodynamic design of the blades and the rims of the guide blading of the impeller. To improve the aerodynamics of aircraft bearing surfaces, it is known that the flow resistance of the bearing surfaces can be reduced by means of boundary layer suction.

Furthermore, there are known structural measures involving the surface of the bearing surfaces by means of which thickening or burbling of the boundary layer can be prevented.

The object of the present invention is thus to improve upon the aerodynamics of components in aircraft gas turbines.

According to the invention, a structure that minimizes boundary layers on the surface of the components is produced by means of structures that are present on the surface of the molded cathodes.

With the inventive structurally modified molded cathode, it is thus possible to produce a suitable structure on the surface of the components such that the structure has boundary-layer-minimizing properties during operation. The component is advantageously an impeller having blades arranged on the outside circumference according to the BLISK technology.

One advantage of this method is that the component manufacturing process can be accelerated by means of the molded cathode according to the present invention. The structurally modified molded cathode makes it possible to manufacture the components in one manufacturing operation. With the inventive molded cathode it is thus possible to contour the components suitably and at the same time provide them with a suitable surface structuring. The contour of the components and the surface structuring should be selected so that the components have a high efficiency during operation.

Thus with the inventive method the step of surface structuring, which is necessary in the state of the art to provide the completely contoured components with a surface structure, is omitted. The finished contour and the finished structure of the components can thus be produced in a single manufacturing step by the method according to this invention.

In an advantageous embodiment of this invention, the structure of the surface of the molded cathodes is designed so that a negative structure in relation to the molded cathode surface is formed on the surface of the blades.

In another advantageous embodiment of this invention the electrochemical machining process is a pulsed processed.

1-2. (canceled)

3. A method for manufacturing blades arranged on the outside circumference of an impeller in a BLISK technology by contouring by means of an electrochemical machining method using molded cathodes, wherein the surface of the blades in contouring is equipped with a negative structure in relation to the molded cathode surface and at the same time a structure that minimizes boundary layers in one manufacturing step.

4. A method according to claim 1, wherein the electrochemical machining method is a pulsed method.
